(19) United States
(12) Patent Application Publication
(10) Pub. No.: US 2005/0237189 A1
(43) Pub. Date: Oct. 27, 2005

(54) Self-propelled cleaner with monitoring camera

(75) Inventor: Takao Tani, Osaka (JP)

Correspondence Address: Yokoi & Co., U.S. A., Inc., 13700 Marina Pointe Drive #1512, Marina Del Rey, CA, 90292, US

(73) Assignee: Funai Electric Co., Ltd., Osaka (JP)

(21) Appl. No.: 11/103,009

(22) Filed: Apr. 11, 2005

(30) Foreign Application Priority Data
Apr. 15, 2004 (JP) JP2004-120605

(51) Int. Cl. G08B 13/00

(52) U.S. Cl. 340/541; 340/545.3

(57) ABSTRACT

The prior arts have a problem that it is not precisely determined whether or not a human entering a room is an intruder, and consequently raising an alarm when there is a slightest possibility of an intruder, a malfunction may result, and raising an alarm only when there is a strong possibility of an intruder, a response to an intruder actually entered the room may be delayed. A self-propelled cleaner according to this invention is capable of executing a phased security, that is, turning on lights, flashing lights, making a loud sound, generating a go-away message, and generating a police report message upon detection of a human suspected of being an intruder, and takes an image of the room at each stage to transmit the resulting image to a family member away from the home, and determines whether or not the security level should be escalated according to an instruction from the family member

### BACKGROUND OF THE INVENTION

1. Field of the Invention

This invention relates to a self-propelled cleaner comprising a body equipped with a cleaning mechanism, a drive mechanism capable of steering and driving the cleaner, and a monitoring camera.

2. Description of the Prior Art

As autonomous traveling robots also serving as a guard, those disclosed in the patent documents 1 to 3 below are known. The patent documents 1 discloses a self-propelled robot that transmits security information wirelessly when it obtains the information and the patent document 2 discloses a robot that makes a sound just like a bark of a watch dog when its human detecting sensor detects an intruder. The patent document 3 discloses an autonomous robot that does not release the lock of the house unless a visitor is identified.
Patent document 1: Japanese Patent Laid-Open No. 2000-342498
Patent document 2: Japanese Patent Laid-Open No. 2002-254374
Patent document 3: Japanese Patent Laid-Open No. 2003-281653

The conventional robots mentioned above can also serve as a guard but cannot determine precisely whether a person entering is an intruder or not. Therefore, designing a robot to raise an alarm if there is any possibility of an intruder may increase a false alarm while designing to raise an alarm only when a person entering is highly likely to be an intruder may delay an action against a real intruder.

### SUMMARY OF THE INVENTION

This invention has been made in view of the above-mentioned problems with the prior arts and an object of the invention is to provide a self-propelled cleaner that realizes highly reliable security.

In view of the above mentioned problems, one aspect of this invention provides a self-propelled cleaner comprising a body equipped with a cleaning mechanism; a drive mechanism capable of steering and driving the said cleaner; a camera device capable of taking an image of a room to guard when an instruction is received and outputting image data; a wireless transceiver capable of transmitting predetermined data to the outside and receiving an instruction from the outside; a control signal transmitter to control electrical appliances including lamps in a room to guard; an intruder information obtaining device to obtain information on an intruder; and a phased guard execution control processor that, when intruder information is obtained from said intruder information obtaining device, based on a plurality of predetermined phased security instructions, controls electrical appliances through said control signal transmitter, takes an image of the room with said camera device, communicates wirelessly with the outside by means of said wireless transceiver, and executes a security task step-by-step in response to instruction from the outside and according to said phased security instructions.

The aspect of this invention as constructed above is capable of obtaining intruder information from said intruder information obtaining device and said phased-security execution control processor executes said security task step-by-step in response to instructions from the outside and according to said plurality of predetermined phased-security instructions when intruder information is obtained from this device. That is, said phased-security execution processor controls electrical appliances in the room, takes an image of the room with said camera device, and communicates with the outside by means of said wireless transceiver, according to said phased security instructions.

Thus, a plurality of phased security tasks are predetermined and the security tasks are executed step-by-step according to instructions from the outside. By asking for instructions from the outside at each stage of security, early reporting is made possible and too early execution of a high level security can be eliminated, resulting in increased reliability as a whole.

Intruder information can be obtained in various ways such as from an intruder detector installed at a door or an intercom. As an example, said intruder information obtaining device is equipped with a human sensor capable of detecting the presence of a human within a predetermined range around the cleaner and said phased security execution control processor controls said drive mechanism to travel the cleaner on a predetermined route to evacuate when said human sensor detects the presence of a human close to the cleaner.

Realizing the phased security will prevent the cleaner from reporting to a security company or the like based on imprecise information but it is possible that the cleaner is found and broken by an intruder. If the cleaner is constructed as mentioned above, the presence of a human within a predetermine range around the cleaner can be detected, which allows said phased security execution control processor to control said drive mechanism to travel the cleaner on a predetermined route to evacuate upon detection of a human close to the cleaner.

Therefore, even if an intruder is present close to the cleaner the worst situation like the cleaner being found or broken by the intruder can be avoided.

Furthermore, if a situation occurs where the cleaner is broken, the phased security may fail to cope with the situation timely. In one aspect of this invention, therefore, said intruder information obtaining device has an acceleration sensor and said phased security execution control processor steps up the security level faster than normal when a large acceleration is detected by said acceleration sensor.

In this aspect, if said acceleration sensor detects a large acceleration when intruder information is obtained, it is possible that the cleaner was attacked by an intruder and therefore said phased security execution control processor steps up the security level faster than normal. This eliminates a delay in execution of the final phase of security.

Various methods of controlling electrical appliances are available. By way of example, it is possible that said control signal transmitter is equipped with an infrared signal transmitter that transmits a infrared signal to remote-control said electrical appliances and said phased security execution control processor controls said electrical appliances by means of said infrared signal from said control signal transmitter.

In this aspect, said phased security execution control processor transmits an infrared signal via said infrared signal transmitter to remote-control said electrical appliance. The infrared signal can be used for many electrical appliances since remote control of electrical appliances are often made with an infrared signal. Besides, mounting an infrared signal receiver and said infrared signal transmitter as a unit allows communications via infrared signals and increases convenience.

As a preferred aspect of asking for instructions from the outside, said phased security execution control processor first lights up a lamp in the room with an infrared signal from said infrared signal transmitter and then takes an image of the room with said camera device. The image data obtained from said camera device is transmitted to the outside via said wireless transceiver.

With the above construction, a lamp in the room is first lit up and then an image of the room is taken with said camera device and the image data obtained from said camera device is transmitted to the outside via said wireless transceiver, which allows the user to obtain a clear picture of the room and give appropriate instructions.

As an aspect of the phased security, it is also possible that said phased security execution control processor flashes a lamp in the room with an infrared signal from said infrared signal transmitter in order to intimidate an intruder.

In this aspect, a flashing lamp in the room will effectively intimidate an intruder since the intruder may assumes that there is someone in the room.

As another aspect of the phased security, it is also possible that said phased security execution control processor causes an audio apparatus in the room to sound to intimidate an intruder by means of an infrared signal from said infrared signal transmitter.

In this aspect, an audio apparatus in the room is caused to sound, which will effectively intimidate an intruder because the intruder assumes from this sound that there is someone in the room.

As another aspect of the wireless communications to the outside, it is possible that said wireless transmitter has a wireless LAN module and connects to a wired LAN via a wireless LAN or communicates with said wired LAN through the Internet.

This aspect allows, on the assumption that a wired LAN is available, information and image data to be transmitted to a predetermined party through a LAN by connecting to an access point provided on said wireless LAN. Therefore, a member of the family can receive information or send instructions if Internet access is available.

In recent years, sending and receiving of electronic mails on the Internet can be implemented easily via cell phones and a wireless LAN environment allowing communications with these cell phones enables reliable sending and receiving of information.

Regarding the cleaning mechanism, a suck-in type cleaning mechanism, a brush type one, or a combination type can be employed. The drive mechanism capable of steering and driving the cleaner can also be implemented in various ways. The drive mechanism can be implemented using endless belts instead of wheels. Needless to say, other constructions such as four wheels or six wheels are also possible.

As a more specific aspect based on those described above, there is provided a self-propelled cleaner having a body equipped with a cleaning mechanism and a drive mechanism equipped with drive wheels that are disposed at the left and right side of said body and their rotations can be controlled individually to enable steering and driving of said cleaner. Said body comprises a camera device that takes an image of the room when instructed and outputs the image data; a plurality of human sensors that are disposed at the sides of said body so as to detect a moving object emitting infrared light based on the variations in the amount of received light; a wireless transceiver with a wireless LAN module capable of connecting to a wired LAN via a wireless LAN, communicating with the outside through said wired LAN and the Internet, transmitting predetermined data wirelessly to the outside, and receiving predetermine instructions from the outside; an infrared control signal transmitter capable of transmitting an infrared signal to remote-control electric appliances including a lamp in the room; and a phased security execution control processor that lights up a lamp in the room with an infrared signal from said infrared signal transmitter when intruder information from said intruder information obtaining device, takes an image of the room with said camera device, transmits the image data obtained from said camera device to the outside via said wireless transceiver, executes control of the electrical appliances in the room through said control signal transmitter, and executes security tasks step-by-step in response to instructions from the outside based on wireless communications with said wireless transceiver and according to said phased security instructions.

In this aspect, the plurality of human sensors that detects a moving object emitting infrareds and an infrared control signal transmitter capable of transmitting an infrared signal to remote control electrical appliances including a lamp in the room are provided. When intruder information is obtained from the human sensor, the phased security execution control processor lights up a lamp in the room with an infrared signal from said infrared signal transmitter, takes an image of the with said camera device, and transmits the image data obtained from said camera device to the outside via said wireless transceiver. Also, said phased security execution control processor executes control of the electrical appliances in the room based on a plurality of predetermined phased security instructions and also causes the wireless LAN of said wireless transceiver to communicate with the outside through a wireless LAN, a wired LAN, and the Internet and perform security tasks in response to instructions from the outside and according to said phased security instructions.

Thus, by realizing interactive communications with the outside and the phased security, the reliability can be improved as a whole.

Other and further objects, features and advantages of the invention will appear more fully from the following description.

### BRIEF DESCRIPTION OF THE DRAWINGS

FIG. 1 is a block diagram showing the schematic construction of a self-propelled cleaner according to this invention.

FIG. 2 is a more detailed block diagram of said self-propelled cleaner.

FIG. 3 is a block diagram of a passive sensor for AF.

FIG. 4 is an explanatory diagram showing the position of a floor relative to the passive sensor and how ranging distance changes when the passive sensor for AF is oriented obliquely toward the floor.

FIG. 5 is an explanatory diagram showing the ranging distance for imaging range when a passive sensor for AF for adjacent area is oriented obliquely toward a floor.

FIG. 6 is a diagram showing the positions and ranging distances of individual passive sensors for AF.

FIG. 7 is a flowchart showing a traveling control.

FIG. 8 is a flowchart showing a cleaning travel.

FIG. 9 is a diagram showing a travel route in a room to be cleaned.

FIG. 10 is an external perspective view of a camera system unit.

FIG. 11 is a side view of a camera system unit showing its mounting procedure.

FIG. 12 is a diagram showing a display for selecting operation mode selection.

FIG. 13 is a flowchart showing the control steps in security mode.

FIG. 14 is a diagram showing the selection of image data output methods.

FIG. 15 is a diagram showing a display for setting an E-mail sending address.

FIG. 16 is a diagram showing a display for setting whether or not evacuation actions are to be taken after taking an image.

FIG. 17 is a flowchart showing actions against an intruder.

FIG. 18 is a flowchart showing evacuation actions.

FIG. 19 is a flowchart showing actions against an attack.

### DESCRIPTION OF THE PREFERRED EMBODIMENTS

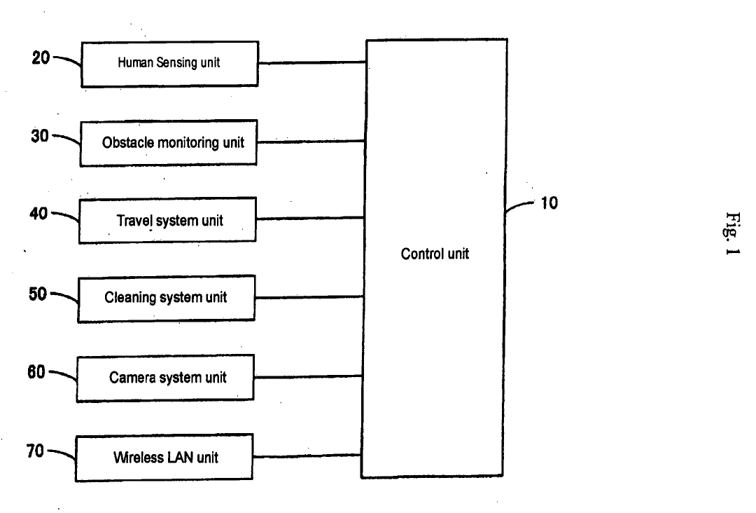

FIG. 1 is a block diagram showing the schematic construction of a self-propelled cleaning according to this invention. As shown in the figure, the cleaner comprises a control unit 10 to control individual units; a human sensing unit 20 to detect a human or humans around the cleaner; an obstacle detecting unit 30 to detect an obstacle or obstacles around the cleaner; a traveling system unit 40 for traveling; a cleaning system unit 50 to perform a cleaning; a camera system unit 60 to take an image of a predetermine range; a wireless LAN unit 70 for wireless connection to a LAN; and an optional unit 80. The body of the cleaner has a flat rough cylindrical shape.

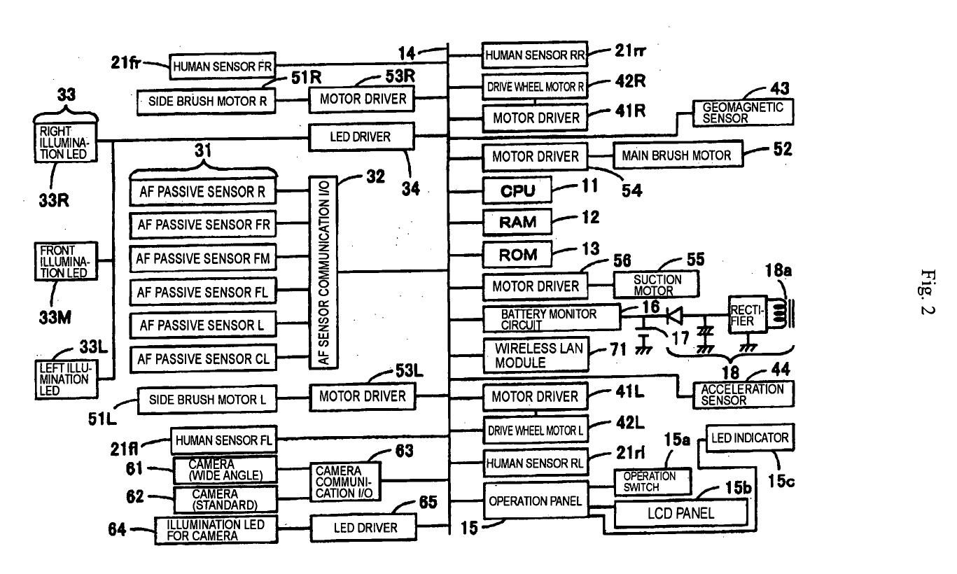

FIG. 2 is a block diagram showing the construction of an electric system that realizes the individual units concretely. A CPU 11, a ROM 13, and a RAM 12 are interconnected via a bus 14 to form the control unit 10. The CPU 11 performs various controls using the RAM 12 as a work area according to a control program stored in the ROM 13 and various parameter tables. The contents of said control program will be described later in detail.

The bus 14 is equipped with an operation panel 15 on which various types of operation switches 15a, an LED display panel 15b, and LED indicators 15c are provided. Although a monochrome LED panel capable of multi-tone display is used for the LED display panel, a color LED panel or the like can also be used.

This self-propelled cleaner has a battery 17 and allows the CPU 11 to monitor the remaining amount of the battery 17 through a battery monitor circuit 16. Said battery 17 is equipped with a charge circuit 18 that charges the battery with an electric power supplied non-contact through an induction coil 18a. The battery monitor circuit 16 mainly monitors the voltage of the battery 17 to detect its remaining amount.

The human sensing unit 20 consists of four human sensors 21 (21fr, 21rr, 21f1, 21r1), two of which are disposed obliquely at the left and right sides of the front of the body and the other two at the left and right sides of the rear of the body. Each human sensor 21 has a light-receiving sensor that detects the presence of a human based on the amount of infrared light received. In order to change the status for output when the human sensor detects a moving object to which an infrared light is radiated, the CPU 11 can obtain detection status of the human sensor 21 via the bus 14. That is, the CPU 11 is allowed to obtain the status of each of the human sensors 21fr, 21rr, 21f1, and 21r1 at predetermined intervals and detect the presence of a human in front of the human sensor 21fr, 21rr, 21f1, or 21rl if the status changes.

Although the human sensor described above detects the presence of a human based on changes in the amount of infrared light, an embodiment of the human sensor is not limited to this. For example, if the CPU's processing capability is increased, it is possible to take a color image of the room to identify a skin-colored area that is characteristic of a human and detect the presence of a human based on the size of the area and/or changes in the area.

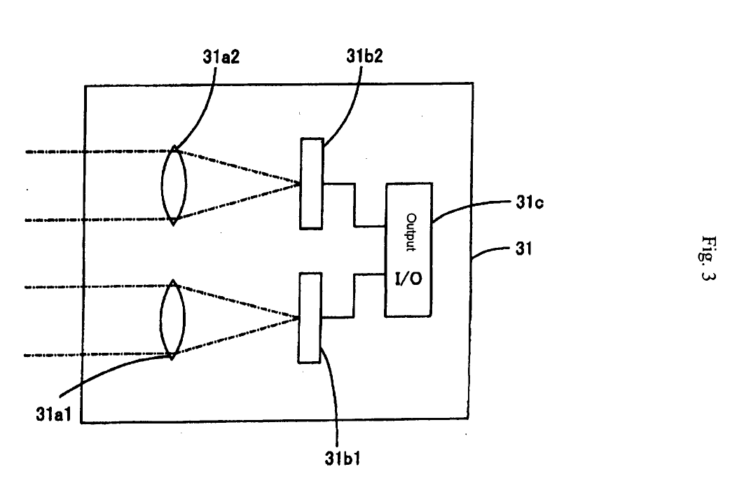

The obstacle monitoring unit 30 comprises the passive sensor 31 (31R, 31FR, 31FM, 31FL, 31L, 31CL) as a ranging sensor for auto focus (hereinafter, called AF); an AF sensor communication I/O 32 as a communication interface to the passive sensor 31; an illumination LED 33; and an LED driver 34 to supply a driving current to each LED. First, the construction of the passive sensor for AF 31 will be described. Fig.3 shows a schematic construction of the passive sensor for AF 31 comprising almost parallel biaxial optical systems 31a1, 31a2; CCD line sensors 31b1, 31b2 disposed approximately at the image focus locations of said optical systems 31a1 and 31a2 respectively; and an output I/O 31c to output image data taken by each of the CCD line sensors 31b1 and 31b2.

The CCD line sensors 31b1, 31b2 has a CCD sensor with 160 to 170 pixels and can output 8-bit data representing the amount of light for each pixel. Since the optical system is biaxial, formed images are misaligned according to the distances, which enables the distance to be measured based on a disagreement between data output from respective CCD line sensors 31b1 and 31b2. For example, the smaller the distance the larger the misalignment of formed images and vice versa. Therefore, an actual distance is determined by scanning data row for each four to five pixels in output of either CCD line sensor, finding a difference between the address of an original data row and that of a discovered data row, and then referencing a “difference to distance conversion table” prepared in advance.

Out of the passive sensors for AF 31R, 31FR, 31FM, 31FL, 31L, and 31CL; the 31FR, 31FM, 31FL are used to detect an obstacle located straight ahead of the cleaner, the 31R, 31L are for detecting an obstacle located immediately ahead of the left or right side of the cleaner, and the 31CL is for detecting a distance to the forward ceiling.

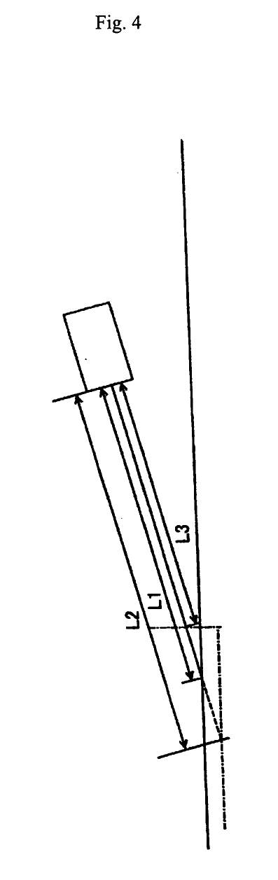

FIG. 4 shows the principle of detecting an obstacle located straight ahead of the cleaner or immediately ahead of the left or right side of the cleaner by means of the passive sensors for AF 31. These passive sensors are mounted obliquely toward a forward floor. If there is no obstacle ahead, ranging distance of the passive sensor for AF 31 is L1 in almost whole image pick-up range. However, if there is a step as shown with a dotted line in the Figure, ranging distance becomes L2, thus making it possible to determine that there is a downward step if ranging distance extends. Likewise, if there is a upward step as shown with a double-dashed line, ranging distance becomes L3. Ranging distance for an obstacle also becomes a distance to the obstacle as in the case of an upward step and thus becomes shorter than a distance to floor.

In this embodiment, if the passive sensor for AF 31 is mounted obliquely toward a forward floor, its image pick-up range becomes about 10 cm. Since the self-propelled cleaner is 30 cm in width, three passive sensors for AF 31FR, 31FM, 31FL are mounted at slightly different angles from each other so that their image pick-up ranges will not overlap. This allows the three passive sensors for AF to detect any obstacle or step within a forward 30 cm range. Needless to say, detection range varies with the specification and/or mounting position of a sensor, in which case the number of sensors meeting actual detection range requirements may be used.

The passive sensors for AF 31R, 31L which detect an obstacle located immediately ahead of the right and left sides of the cleaner are mounted obliquely toward a floor relative to vertical direction. The passive sensor for AF 31R disposed at the left side of the body faces opposite direction so as to pick up an image of the area immediately ahead of the right side of the body and to the right across the body. The passive sensor for AF 31L disposed at the right side of the body also faces the opposite direction so as to pick up an image of the area immediately ahead of the left side of the body and to the left across the body.

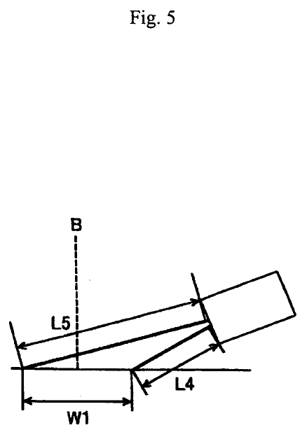

If said two sensors are disposed so that each sensor picks up an image of the area immediately ahead thereof, the sensor must be mounted so as to face a floor at a steep angle and consequently the image pick-up range becomes narrower, thus making it necessary to provide multiple sensors. To prevent this, the sensors are intentionally disposed cross-directionally to widen the image pick-up range so that required range can be covered by as few sensors as possible. Meanwhile, mounting the sensor obliquely toward a floor relative to the vertical direction means that the arrangement of CCD line sensors is vertically directed and thus the width of an image pick-up range becomes W1 as shown in FIG. 5. Here, distance to the floor is short (L4) on the right of the image pick-up range and long (L5) on the left. If the border line of the side of the body is at the position of the dotted line B, an image pick-up range up to the border line is used for detecting a step or the like and an image pick-up range beyond the border line is used for detecting a wall.

The passive sensor for AF 31CL to detect a distance to a forward ceiling faces the ceiling. The distance between the floor and ceiling to be detected by the passive sensor 31CL is normally constant. However, as cleaner approaches a wall the wall, not the ceiling, becomes the image pick-up range and consequently a ranging distance gets shorter, allowing a more precise detection of a forward wall.

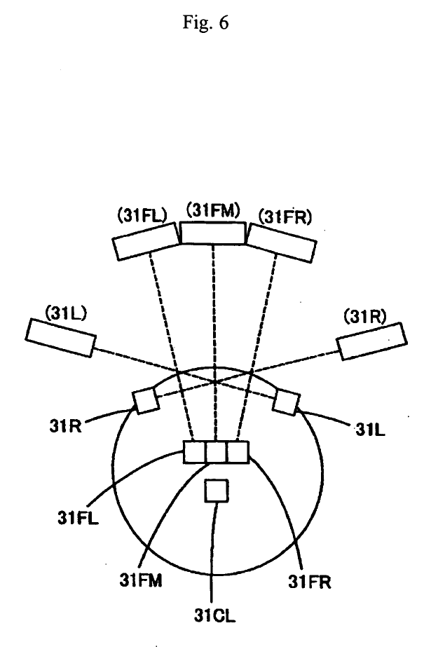

FIG. 6 shows the positions of the passive sensors for AF 31R, 31FR, 31FM, 31FL, 31L, and 31CL mounted on the body and their corresponding image pick-up ranges in parentheses. The image pick-up ranges for a ceiling are not shown.

A right illumination LED 33R, a left illumination LED 33L, and a front LED 33M, all of which are white LED, are provided to illuminate the image pick-up ranges of the passive sensors for AF 31R, 31FR, 31FM, 31FL, 31L. An LED driver 34 supplies drive current to turn on these LEDs according to a control command from the CPU 11. This allows obtaining effective pick-up image data from the passive sensors for AF 31 even at night or at a dark place such as under a table.

The traveling system unit 40 comprises motor drivers 41R, 41L; drive wheel motors 42R, 42L; a gear unit (not shown); and drive wheels, both of which are driven by the drive wheel motors 42R, 42L. The drive wheel is disposed at the right and left side of the body, one at each side, and a free-rotating wheel without a driving source is disposed at the front center of the bottom of the body. The rotation direction and rotation angle of the drive wheel motors 42R, 42L can be finely regulated by the motor drivers 41R, 41L respectively and each of the motor drivers 41R, 41L outputs a corresponding drive signal according to a control command from the CPU 11. Furthermore, the rotation direction and rotation angle of actual drive wheels can be precisely detected based on the output from a rotary encoder that is mounted integrally with the drive motors 42R, 42L. Also, it is possible to dispose free-rotating driven wheels near the drive wheels, instead of directly coupling the rotary encoder to the drive wheels, and feed back the amount of rotation of said driven wheels. This enables actual amount of the drive wheels to be detected even when the drive wheels are skidding. The traveling system unit 40 further comprises a geomagnetic sensor 43 that enables traveling direction to be determined against geomagnetism. An acceleration sensor 44 detects accelerations in three axis (X, Y, Z) directions and outputs detection results.

Various types of gear unit and drive wheels can be adopted, including drive wheel made of a circular rubber tire and an endless belt.

This cleaning mechanism of this self-propelled cleaner comprises side brushes disposed at both sides of the front of the cleaner that sweeps together dust around the center of the body to drive the suction fan and the like existing on the floor around both sides of the body, a main brush that scoops up the dust collected around the center of the body, and a suction fan that sucks in the dust scooped up by the main brush and feeds it to a dust box. The cleaning system unit 50 comprises side brush motors 51R, 51L and a main brush motor 52 to drive corresponding brushes; motor drivers 53R, 53L, 54 that supply drive current to the respective brush motors, and suction motor to drive the suction fan; and a motor driver 56 that supplies current to said suction motor. During a cleaning, the side brushes and a main brush are controlled by the CPU 11 based on floor condition, condition of the battery, instruction of the user, etc.

The camera system unit 60 is equipped with two CMOS cameras 61, 62 with different visual field angles, which are disposed at the front of the body and set to different elevation angles. The camera system unit further comprises a camera communication I/O 63 that instructs each of the cameras 61, 62 to take an image of a floor ahead and outputs the taken image; an illumination LED for camera 64 consisting of 15 white LEDs directed to an image to be taken by the cameras 61, 62; and an LED driver 65 to supply drive current to said LED for illumination.

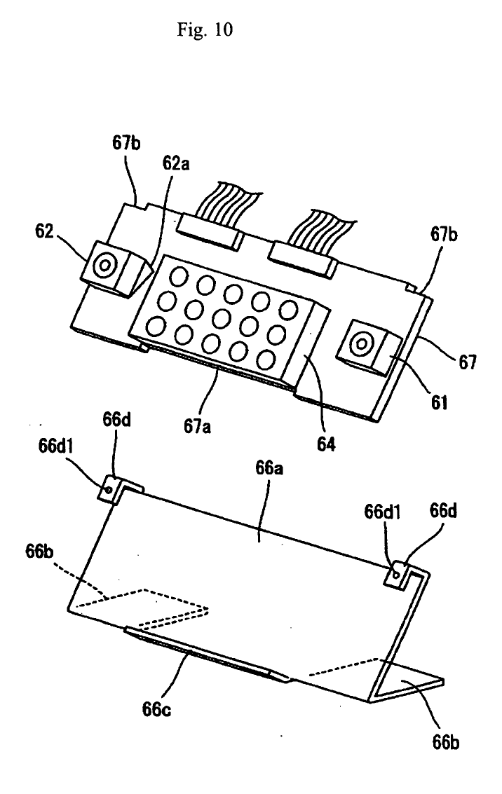

FIG. 10 is a perspective view of an appearance of a camera system unit 60.

The optional camera system unit 60 can be mounted on a mounting base 66 on the body that is formed by bending a metal plate. A base board 67 on which said CMOS cameras 61, 62, camera illumination LEDs 64, and the like are mounted is provided and designed to be screwed to said mounting base 66. The mounting base 66 comprises a base 66a; two legs 66b that extend backward from both sides of the lower edge of said base 66sa in order to hold the base at about 45 degrees relative to horizontal direction; a convex support edge 66c that is bent at about right angle relative to the base 66a to support the lower edge of said base board 67; and fixing brackets 66d with a tapped hole for each that extend upward flatly from both ends of the upper edge of the base 66a and are bent at 90 degrees twice so that the end side faces the base 66a in parallel.

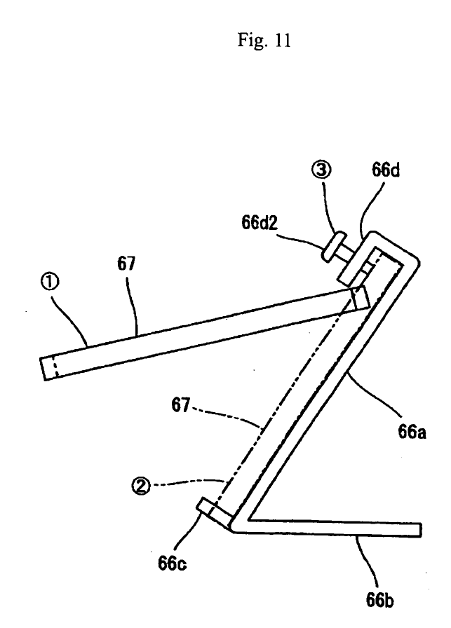

As shown in FIG. 11, first insert the upper end of the base board 67 between said fixing bracket 66d and the base 66a, and when the end of the base board 67 is inserted to the innermost push the lower end of the same onto the convex support edge 66c, and finally fix the base board 67 by screwing a male screw 66d2 into a female screw 66d1 so that the base board 67 will not move. At the both sides of the upper end of the base board 67 and at the center of the lower end of the same, cuts 67a, 67b matching said fixing bracket 66d and the convex support edge 66c respectively are formed to allow precise positioning.

A CMOS camera 61 is a wide angle camera with a degree visual field angle of 110 degrees that is mounted on the base board 67 so that shooting direction is at right angle to the base board 67. Since its visual field angle is 110 degrees and the base board 67 itself is mounted on the mounting base 66 that is tilted at 45 degrees, the imaging range becomes from 10 to 110 degrees below the horizontal plane. Therefore, the imaging range includes floor surface.

The CMOS camera 62 is a standard angle camera with a visual field angle of 58 degrees and mounted on the base board 67 with a wedge-shaped adapter 62a placed under the same so that its shooting direction is at 15 degrees relative to the base board 67. Since the visual field angle is 58 degrees, the imaging range is from 1 to 57 degrees relative to a horizontal plane. That is, if the camera is at a distance of 2 m from an object, the imaging range becomes from 0.034 to 3.078 m, in which case the object is likely to be imaged. In contrast, if an object is at a distance of 1 m from the camera, the imaging range becomes 0.017 to 1.539 m, in which case an intruder may not be imaged by the camera depending on his or her posture.

However, since the imaging range of the CMOS camera 61 is from 10 to 110 degrees below a horizontal plane, which is sufficient as an imaging range, and a range from 1 m above the floor (i.e. the height of the camera) up to the ceiling is covered, it is highly likely that the face of an intruder is imaged.

Furthermore, since the CMOS cameras 61, 62 starts to take an image immediately after the cleaner is positioned and continues to take an image as described below, the time for positioning and focusing of the camera is not required and therefore imaging an opportunity will not be lost.

A wireless LAN unit 70 has a wireless LAN module 71 and the CPU 11 is capable of wirelessly connecting to an external LAN according to a predetermine protocol. If an access point (not shown) is available, it is possible to connect the wireless LAN module 71 through said access point to an external wide area network, such as the Internet, via routers or the like. This allows ordinary sending and receiving of E-mails or browsing Web sites over the Internet. The wireless LAN module 71 comprises a standardized card slot and a standardized wireless LAN card. Needless to say, other standardized card can be connected to the card slot.

An optional unit 80 is equipped with an infrared communication unit and an alarm generation device. The infrared communication unit transmits an infrared signal for remote control corresponding to an electrical appliance including a lamp inside the room. In this embodiment, the infrared communication unit serves as a remote control device for a lamp or television. An infrared signal to remote-operate a lamp or television is once transmitted from each remote control device to the infrared communication unit, and the pattern of the received infrared signal is stored in the same to be transmitted according to an instruction from said CPU 11. Also, identification of the pattern of an infrared signal can be implemented by causing the infrared communication unit to output a digital pattern conveyed by a carrier to the CPU 11 and to be detected by the same. The alarm generation device is equipped with a voice synthesizer and a speaker to raise an alarm for an intruder.

Next, the operation of the self-propelled cleaner constructed as above will be described.

(1) Cleaning Operation

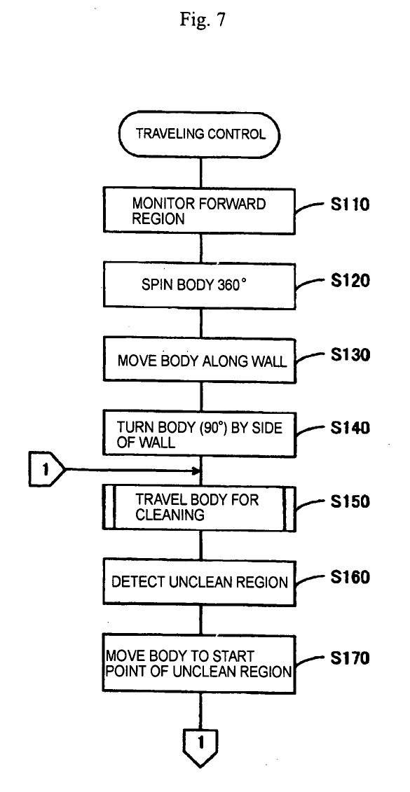

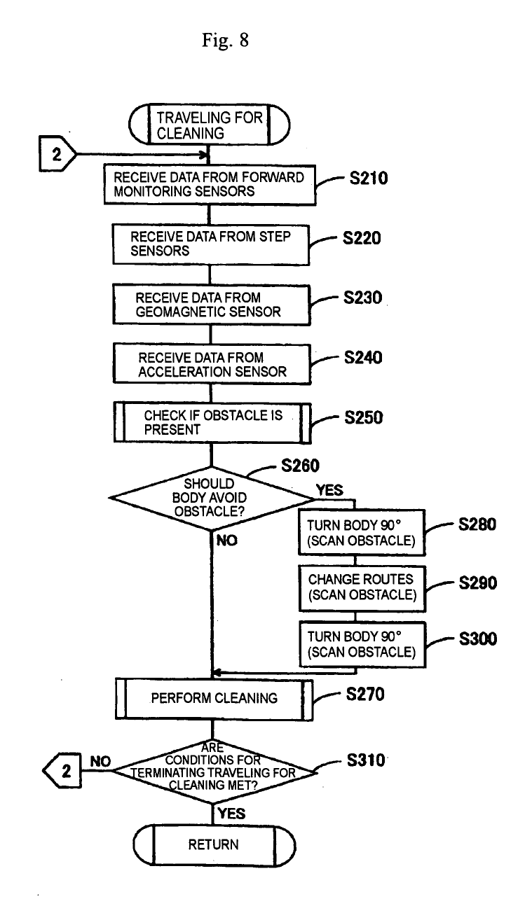

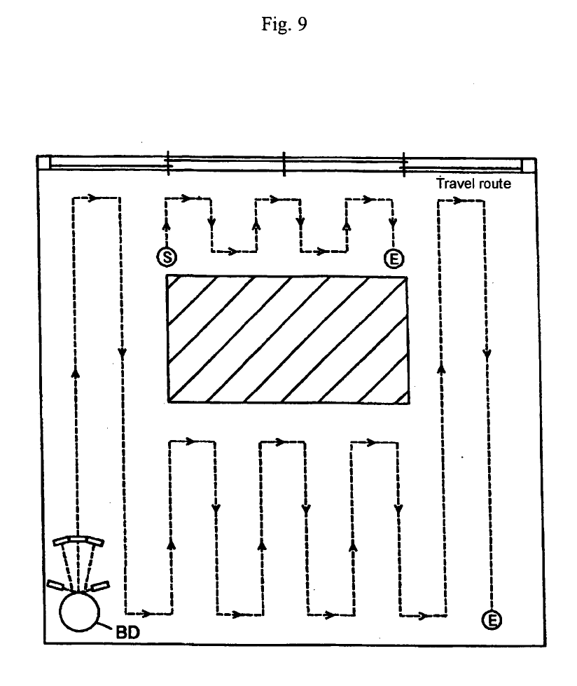

FIG. 7 and FIG. 8 show flowcharts corresponding to the control programs said CPU 11 executes and FIG. 9 shows a route along which a the self-propelled cleaner travels according to said control programs.

When the power is turned on the CPU 11 starts to the travel control shown in FIG. 7. In Step S110, detection results of the passive sensor for AF 31 are input to monitor a forward region. The detection results of the passive sensors for AF 31FR, 31FM, 31FL are used for monitoring a forward region. If the area is flat, the distance to an obliquely downward floor, L1, as shown in FIG. 4 can be obtained from an image taken by these passive sensors for AF. Based on the detection results of the individual passive sensors for AF 31FR, 31FM, 31FL, it can be determined whether or not the front floor as wide as the body is flat. At this point, however, no information has been obtained about an area from the position immediately before the body to the position each of the passive sensors for AF 31FR, 31FM, 31FL is facing, and consequently that area becomes a blind spot.

In Step S120, the CPU 11 commands the motor drivers 41R, 41L to drive the drive wheel motors 42R, 42L respectively so that rotational direction is different from each other but amount of rotation is the same. This causes the body to start turning at the same position. Since the amount of rotation of the drive motors 42R, 42L required for a 360 spin turn at the same position is already known, the CPU 11 commands the motor drivers 41R, 41L to give the drive wheel motors that amount of rotation.

During a spin turn, the CPU 11 inputs detection results of the passive sensors for AF 31R, 31L to determine the situation of the position immediately before the body. The detection results during this period almost eliminate said blind spot and thus an existence of a flat floor around the body can be detected if there is no step or obstacle.

In Step S130, the CPU 11 commands the motor drivers 41R, 41L to give same amount of rotation to the drive wheel motors 42R, 42L respectively. This causes the body to start moving strait. During moving straight, the CPU 11 inputs detection results of the passive sensors for AF 31FR, 31FM, 31FL to move the cleaner ahead while determining whether or not any obstacle exists ahead. If a wall, i.e., an obstacle, can be detected ahead from said detection results, the cleaner stops at a predetermined distance before the wall.

In Step S140, the cleaner turns to the right 90 degrees. The cleaner stops at a predetermined distance before the wall in Step S130. This predetermine distance is a distance within which the body can turn without colliding against the wall and also the passive sensors for AF 31R, 31L can detect an obstacle to determine the situation immediately before and on the right and left sides. That is, in Step S130 the cleaner stops based on detection results of the passive sensors for AF 31FR, 31FM, 31FL, and when turning 90 degrees in Step S140, the cleaner stops at a distance within which at least the passive sensor for AF 31L can detect the position of a wall. When turning 90 degrees, the situation of the position immediately ahead of the cleaner is determined beforehand based on detection results of said passive sensors for AF 31R, 31L. FIG. 9 shows a situation where a cleaning is started at the lower left corner of a room (cleaning start position) as viewed from the top, where the cleaner thus reached.

There are various methods for the cleaner to reach a cleaning start position other than the method mentioned above. For example, since simply turning right 90 degrees when the cleaner reaches a wall, a cleaning will be started at the middle of the first wall. In order to reach the optimum start position at the lower left corner of a room as shown in FIG. 9, it is desirable for the cleaner to turn left 90 degrees, when it comes up against a wall, move forward to the front wall, and turn 180 degrees when the cleaner reaches the wall.

In Step S150, a cleaning travel is performed. FIG. 8 shows a more detailed flow of said cleaning travel. Before traveling forward, detection results of various sensors are input in steps S210 to S240. Step S210 inputs data from forward monitoring sensors, specifically detection results of the passive sensors for AF 31FR, 31FM, 31FL, 31CL, which is used to determine whether or not an obstacle of wall exists ahead of the traveling range. The forward monitoring includes a ceiling in a broad sense.

Step S220 inputs data from step sensors, specifically detection results of the passive sensors for AF 31R, 31L, which is used to determine whether or not a step exists immediately before the traveling range. When traveling along a wall or obstacle in parallel, a distance to the wall or obstacle is measured and data thus obtained is used to determine whether or not the cleaner is moving in parallel to the wall or obstacle.

Step S230 inputs data from a geomagnetic sensor, specifically the geomagnetic sensor 43, which is used to determine whether or not travel direction varies during a forward travel. For example, an angle of geomagnetism at the start of a cleaning travel is stored in memory and if an angle detected during traveling differs from the stored angle, then the travel direction is corrected back to the original angle by slightly changing the amount of rotation of either left or right drive wheel motors of 42R, 42L. For example, if travel direction changed toward an angle-increasing direction (except for a change from 359 degree to 0 degree), it is necessary to correct the pass toward left direction by issuing a drive control command to the motor driver 41R, 41L to increase the amount of rotation of the right drive wheel motor 42R slightly more than that of the left drive wheel motor 42L.

Step S240 inputs data from an acceleration sensor, specifically detection results of the acceleration sensor 44, which is used to check for travel condition. For example, if an acceleration toward a roughly constant direction can be detected at the start of a forward travel, it is determined that the cleaner is traveling normally. However, if a rotating acceleration is detected, it is determined that either drive wheel motor is not driven abnormally. Also, if an acceleration exceeding a normal range of values is detected, it is determined that the cleaner fell from a step or overturned. If a large backward acceleration is detected during a forward travel, it is determined that the cleaner hit an obstacle located ahead. Although direct control of the travel, such as maintaining a target acceleration by inputting an acceleration value or determining the speed of the cleaner based on the integral value as mentioned above, is not performed, acceleration values are effectively used to detect abnormalities.

Step S250 determines whether an obstacle exists based on detection results of the passive sensors for AF 31FR, 31FM, 31CL, 31FL, 31R, 31L that have been input in steps S210 and S220. The determination of an obstacle is made for the front, ceiling, and position immediately ahead. The front means an obstacle or a wall, the position immediately ahead means a step as well as situations on the right and left sides beyond the traveling range, such as existence of a wall. The ceiling is used to identify an exit of the room without a door by detecting a head jamb or the like.

Step S260 determines whether or not the cleaner need to get around by making a comprehensive assessment of the results of each sensor. If the cleaner need not to get around a cleaning process in Step S270 is performed. The cleaning process is a process of sucking in dust on a floor while rotating the side brush and the main brush, specifically, issuing a command to drive the motor drivers 53R, 53L, 54, 56 to drive motors 51R, 51L, 52, 55 respectively. Needless to say, said command is issued at all times during a travel and is stopped when a terminating condition described below is satisfied.

In contrast, if it is determined that getting around is necessary the cleaner turns right 90 degrees in Step S280. This turn is a 90 degree turn at the same position and is caused by instructing the motor drivers 41R, 41L to rotate the drive wheel motors 42R, 42L in different direction from each other and give a driving force to provide the amount of rotation required for a 90 degree turn. The right drive wheel is rotated backward and the left drive wheel is rotated forward. While the wheels is turning, detection results of step sensors, specifically the passive sensors for AF 31R, 31L, are input to determine whether or not an obstacle exist. For example, when an obstacle is detected in front and the cleaner is turned right 90 degrees, if the passive sensor for AF 31R does not detect a wall immediately ahead of the right, it may be determined that the cleaner comes near the front wall. However, if the passive sensor detects a wall immediately ahead of the right even after the turning, it maybe determined that the cleaner is at a corner. If neither of the passive sensors for AF 31R, 31L detects an obstacle immediately ahead, it may be determined that the cleaner comes near a wall but a small obstacle.

In Step S290, to change the travel route, the cleaner travels forward while scanning obstacles. When the cleaner comes near a wall, it turns right 90 degrees and moves forward. If the cleaner stops just before the wall the forward travel distance is about the width of the body. After moving forward by that distance, the cleaner performs a 90 degree right turn again in Step S300.

During this traveling, scanning of obstacles on front right and left sides is performed at all times to identify the situation and the information thus obtained is stored in memory as information on the presence or absence of an obstacle in the room.

Meanwhile, a 90 degree right turn is made twice in the above description and therefore if a 90 degree right turn is made when another wall is detected in front, the cleaner returns to the original place. To prevent this, the 90 degree turn is to be performed alternately between right and left directions, such as, if the first turn is to the right, the second is to the left, the third is to the right and so on. Accordingly, odd time turns to circumvent an obstacle are to the right, and even time turns are to the left.

Thus, the cleaner travels in a zigzag in the room while scanning obstacles and getting around them. Step S310 determines whether or not the cleaner arrived at the terminal position of the room. A cleaning travel terminates either when the cleaner traveled along the wall after the second turn and then detected an obstacle or when the cleaner moved into an already traveled area. That is, the former is a terminating condition that occurs after the last end-to-end zigzag travel and the latter is a terminating condition that occurs when a cleaning travel is started again upon discovery of a not yet cleaned area as described below.

If neither of these terminating conditions is satisfied, a cleaning travel is repeated from Step S210. If either terminating condition is satisfied, the subroutine for this cleaning travel is terminated and control returns to the process shown in FIG. 7.

After returning to the process, Step S160 determines whether there is any area not yet cleaned based on the previous travel route and situations around the travel route. Various well known methods can be used for determining whether or not not-yet cleaned areas exist, for example, the method of mapping and storing a past travel route can be used. In this embodiment, the past travel route and the presence of absence of walls detected during the travel are being written on a map reserved in memory area, based on detection results of said rotary encoder. It is determined whether or not surrounding walls are continuous, surrounding areas of detected obstacles are also continuous, and the cleaning travel covered all the areas excluding the obstacles. If a not-yet cleaned area is found, the cleaner moves to the start point at the not-yet cleaned area in Step S170 to resume a cleaning travel from Step S150.

Even if several not-yet cleaned areas around the floor is detected, it is possible to eliminate those areas eventually by repeating the detection of a not-yet cleaned area whenever the cleaning travel terminating condition mentioned above is satisfied.

(2) Security Mode Operation

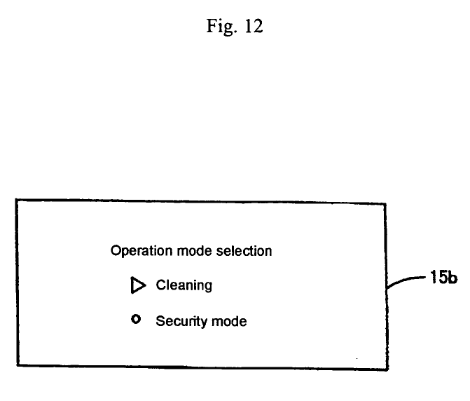

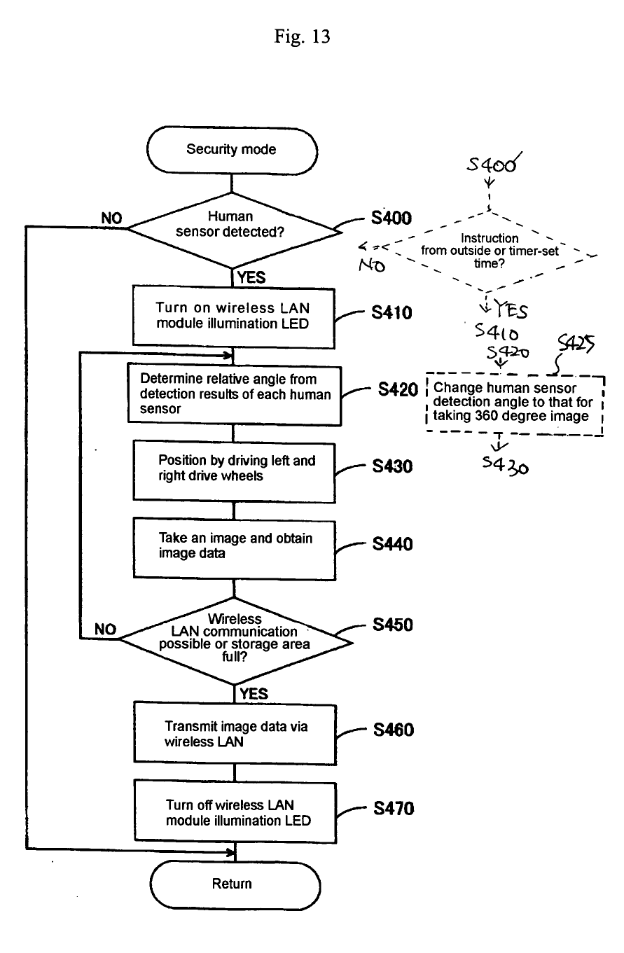

FIG. 12 shows a display panel 15b for operation mode selection. If a camera system unit 60 is mounted, operation mode can be selected . If security mode is selected with a operation 15a, an operation for security mode is executed according to the flowchart shown in FIG. 13.

In security mode, detection results of each human sensor 21fr, 21rr, 21fl, 21rl are input in Step S400. If none of these human sensors did not detect a human, the security mode is finished once, and after other processing is performed, the security mode is repeatedly activated periodically.

If any of the human sensors 21fr, 21rr, 21fl, 21rl detects something like a human in Step S400, the wireless LAN module 71 and the illumination LED 64 are turned off in Step S410. Since the security mode must be activated at all times while no family member is present, power saving is highly required for a battery-operated self-propelled cleaner. Therefore, only the essential components are to be activated while the cleaner is standing by and the other components are turned on as needed. The wireless LAN module 71 is also not activated during a standby period and turned on if something like a human is detected.

In Step S420, a relative angle between a detected object and the body is detected based on detection results of each human sensor 21fr, 21rr, 21fl, 21rl. Each human sensor 21 either outputs the infrared intensity of a moving object emitting an infrared or simply outputs the presence or absence of such an object.

In the latter case, i.e., infrared intensity is output, it is possible that not a single human sensor 21 but a plurality of human sensors 21 detect such an object. In this case, based on the detection outputs from two human sensors 21 that detect a stronger infrared, the direction (angle) of the moving object emitting an infrared is detected within an angle range of 90 degrees between the facing directions of these two human sensors. At this time, an intensity ratio of the detection outputs of the two human sensors 21 is calculated, and a table previously prepared by conducting experiments using said intensity ratio is referenced. Since an intensity ratio and an angle are stored correspondingly in this table, the angle of a detected object within said range of 90 degrees can be determined. Furthermore, anangle relative to the body is determined based on the mounting position of the two human sensors 21 using detection results. For example, if two human sensors 21 that detect a stronger infrared are right-side human sensors 21fr, 21rr, and an angle of 30 degrees on the side of the human sensor 21fr within a 90 degree range is determined by referencing the intensity ratios in said table, that angle is 30 degrees in front within a 90 degree range on the right side, and therefore the relative angle to the front of the body is 45+30=75 degrees.

On the other hand, in the case of simply detecting the presence or absence of an moving object emitting an infrared, only eight relative angles to the body are detected. That is, if only one of the human sensors 21 outputs a detection result, the angle of the mounting position of the human sensor 21 that outputs said detection result is the relative angle. If two human sensors 21 output a detection result, the middle angle between the mounting positions of these two human sensors 21 is the relative angle, and if three human sensors 21 output a detection, the angle of the human sensor 21 is the relative angle. That is, when a plurality of human sensors are mounted at equal intervals, if even number of human sensors are mounted, the angle at a position in the middle of central two human sensors is the relative angle, and if odd number, the angle of the mounting angle of a centermost human sensor is the relative angle.

In Step S430, the left and right drive wheels are activated so that the front of the body is positioned to face said relative angle. This is a turn-around movement, i.e. a turn at the same position and therefore a command is given to the motor drivers 41R, 41L to rotate the left and right drive wheel motors 42R, 42L a predetermined amount of rotation.

In Step S440, after the positioning above is finished, a command is given to the two CMOS cameras 61, 62 to take an image and the resulting image data is obtained. Giving the command and obtaining the data are performed through the bus 14 and the communication I/O 63.

After obtaining the image data, in Step S450 it is determined whether or not communications by means of the wireless LAN module is possible or whether or not the storage area is full, and steps S420 to S440 are repeated until either of these conditions is satisfied. That is, since the wireless LAN module 71 is not activated until turned on in Step S410, it usually takes some time to activate and make available for communications. Because of this, the image data cannot be always transmitted immediately after an image is taken and therefore taking further images until the wireless LAN module becomes available for communication, rather than simply waiting for that state, may prevent possible loss of image taking opportunities. Accordingly, repeating an image pick-up until the communication is enabled is selected.

It is necessary to store the image data in memory but storage capacity is limited. Because of this, it is not always possible to continue an image pick-up operation during a period of standing by, and therefore an image pick-up operation is stopped if storage area becomes full.

If either condition is satisfied in Step S450, the image date is transmitted through the wireless LAN in Step S460, the wireless LAN module and the illumination LED 64 are turned of. Thereafter, the security mode is periodically activated again to continue monitoring.

Meanwhile, it is desirable to obtain the image data from both of the two CMOS cameras 61, 62. However, it is possible for the user to select a serial image-pickup with a wide angle camera or a serial image-pickup with a standard angle camera. It is also possible, though anomalistic, to take only one image with a wide angle camera and thereafter use a standard angle camera. This is because, if it takes time to transfer image data, in view of the time required to transfer a plurality of image data, there is a case where obtaining a plurality of images taken with a standard angle camera is more meaningful than obtaining more than one image taken by a wide angle camera. Also possible is to slightly turn the body after taking an image and take another image, and so on, in order to compensate for the narrow imaging range of a standard angle camera. In this case, it is possible to first take an image with the camera faced in the direction of eliminating said relative angle, then slightly turn the body to the left relative to the previous position and take an image, and turn to the right and take an image, and so on. Needless to say, imaging range can be widened by increasing gradually the extent of the turn.

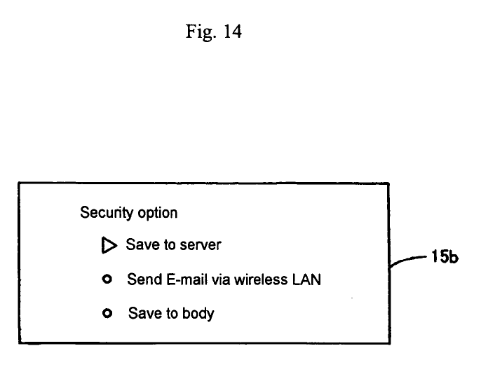

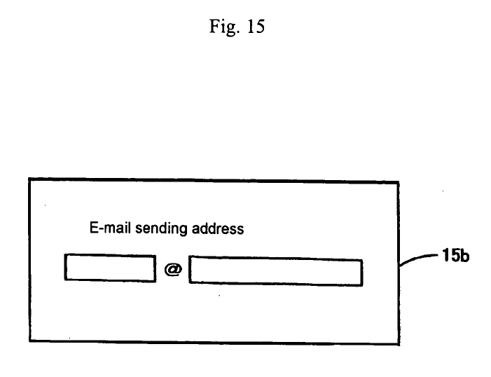

In the embodiment described above, image data is transmitted through a wireless LAN. It may be transmitted to a predetermined storage area of a server or transmitted as an attachment to an E-mail via the Internet. In this case, there is available a security option that allows transmission method to be selected with the LCD panel 15b as shown in FIG. 14. The example shown here displays “Save to server”, “Transmit E-mail via wireless LAN”, and “Store in body”, one of which can be selected with an operation switch 15a. When transmitting by an E-mail, the destination of an E-mail can be set as shown in FIG. 15.

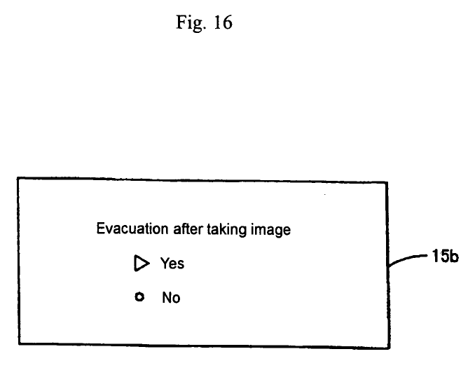

In the above embodiment, only the image taking and transmitting operations are performed. After an image is taken, its image data cannot be transmitted through a wireless LAN for some time, and during that time the body may be broken by an intruder. To prevent this, it is possible to allow the cleaner to evacuate after taking an image. FIG. 16 shows a selection screen of the LCD panel 15b on which evacuation behavior can be selected. As an evacuation behavior, backing zigzag or fleeing into a predetermined shelter is conceivable. A narrow space such as between two pieces of furniture where this self-propelled cleaner can move into is desirable.

In this embodiment, the image pickup operation is to be performed based on detection results of the human sensors, but the user may be worried about the state of the home while away from it. In that case, it is possible to add a processing shown with a dotted line in FIG. 13.

In Step S400 above, only when the human sensors 21fr, 21rr, 21fl, 21rl detect an object like a human, the processing in S410 and later steps are performed. In this variation, “there is an instruction from the outside” and “current time is the timer-set time” are added to the condition for performing S410 and later steps. The former condition determines whether or not there is an instruction from the outside by analyzing the instructions included in E-mails or the like transmitted through a wireless LAN for transmitting image data. The latter condition determines whether or not current time is the time preset by the timer or the preset periodical time. Even if either of these conditions are satisfied, the human sensors 21fr, 21rr, 21fl, 21rl do not detect an object like a human, the detection angle in Step S420 is meaningless. Meanwhile, since the cameras are trying to take an image of an intruder who may exist or may not exist, taking images over a 360 degree range is desirable. In Step S425, therefore, images are taken over a 360 degree range by generating detection angles indicating as if an intruder were turning around the cleaner by using the angles obtained by dividing 360 degrees into a predetermined angle as the detection angles. This allows responding to instructions from the outside through wireless communications with the outside or taking an image of the room periodically to transmit the image data.

(3) Other Embodiments of the Security Mode Operation

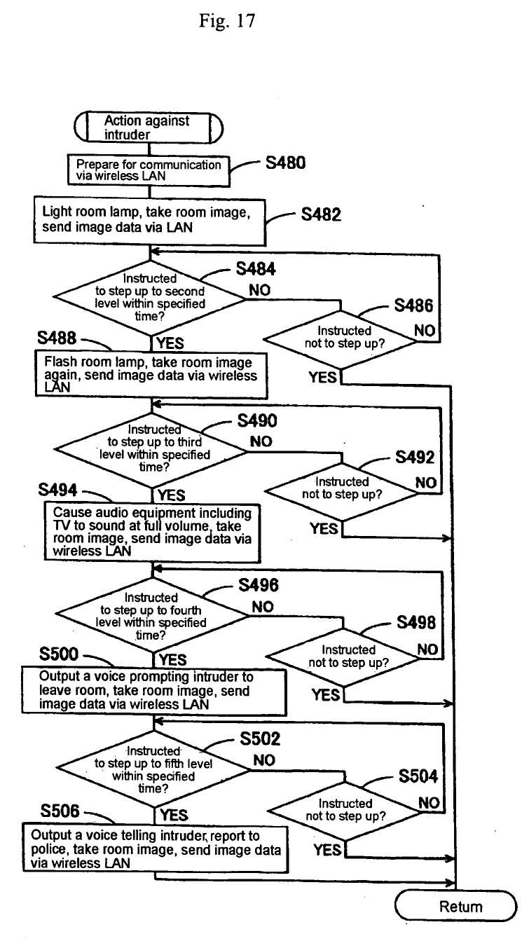

FIG. 17 is a flowchart of the action against intruder processing that is performed as an alternative to steps S410 to S470 in the security mode described above.

The human sensor 21 detected a human as an intruder in Step S400 above and consequently a phased security is performed in Step S480 and later. Here, the detection result of the human sensor 21 corresponds to intruder information. In Step S480, the preparation for transmission through a wireless LAN is made. In Step S482, a lamp in the room is lit, an image of the room is taken, and its image data is transmitted via a wireless LAN.

Since the infrared communication unit has already been arranged to transmit the infrared signal pattern for remote-controlling a lamp in the room, the CPU 11 instructs the said infrared communication unit to transmit an infrared signal to light up the lamp. Also, the CPU 11 instructs the two CMOS cameras 61, 62 to take images and obtains the image data after images are taken. The instructions to take images and obtain the image data are made via the bus 14 and the camera communication I/O 63. It is possible to perform the positioning of the cameras beforehand as in Step S430. After the image data is obtained, that data is transmitted via a wireless LAN. A destination to which the data is sent is specified by selecting “Transmit E-mail via wireless LAN” on the LCD display panel 15b shown in FIG. 14 and then specifying a destination with the E-mail sending address shown in FIG. 15.

With this, the first level security is realized. That is, when an intruder comes in the room, a room lamp is turned on to intimidate the intruder, and at this point an image of the room is taken and transferred to a family member away from the home.

In Step S484, it is determined whether or not an instruction to step up the second level security within a specified period of time. Image data of the room is already transmitted to the family member in Step S482 and therefore he or she has confirmed the image sent with, for example, a cell phone. If no intruder or trace of intrusion appears on the image, the family member may judge that step-up to the second level is not necessary. If the family member definitely judged so, he or she will send an E-mail including a word “Unnecessary” to the self-propelled cleaner via the Internet, a wired LAN, and an wireless LAN. The cleaner determines whether or not an “Instruction to prohibit step-up security level” is issued in Step S486, in addition to the judgment in Step S484, and the details of this processing correspond to the processing for receiving an E-mail and determining whether or not the word “Unnecessary” is included in said E-mail. If “Unnecessary” is included, the cleaner will judge that “step-up is not allowed”. If an E-mail is not received or the word “Unnecessary” is not included in a received mail, the cleaner will not judge that “step-up is not allowed”.

If the family member judges that security level should be stepped up to the second level immediately, he or she sends an E-mail including a word “Step up”. The self-propelled cleaner performs the second level security unless a definite “Step up” instruction is received, no response is made within specified time, or a definite “Unnecessary” instruction is received. Since the family member does not necessarily receive and read an E-mail from the cleaner in real time, a period of time in excess of which a time over occurs is specified.

Step S488 corresponds to the second level security, and flashes an illumination in the room, takes an image of the room again, and transmits the image data through a wireless LAN. Flashing of the illumination in the room is realized by causing the CPU 11 to command the infrared communication unit to transmit an corresponding infrared signal. The image pick-up and data transmission is performed in the same way as in Step S482

With this, if there is an intruder, it is possible to intimidate the intruder into assuming that there may be someone in the room by flashing a lamp in the room several times. The intruder should choose to flee without taking out anything unless he or she is definitely seen by someone and therefore the intimidation by flashing the lamp is likely to be effective. Needless to say, an image of the room is taken even after flashing of the room lamp and the image data is transmitted to a family member away from the home. This realizes the second level security.

Step S490 determines whether or not there is an instruction to step up to a third level security within a specified period of time, and Step S492 determines whether or not there is an “instruction to prohibit step-up”. These determinations are identical with steps S484 and S486. After a family member attempted to intimidate an intruder by flashing a lamp in the room, if the family member can definitely judge that the intruder has fled, the family member only sends an E-mail including a word “Unnecessary”. On the other hand, if an image of the intruder still remains or there is a sign of the intruder, the family member judges that the security level should be stepped up to the third level immediately and sends an E-mail including the word “Step up”.

Step S494 corresponds to the third level security, and causes an audio apparatus including a television to sound at a large volume, takes an image of the room, and transmits the image data to the outside through a wireless LAN. Like illumination, the infrared communication unit can transmit the pattern of an infrared signal to remote-control apparatuses capable of generating sound, the CPU 11 commands the infrared communication unit to cause these apparatuses to make a loud sound, for example, issue a control signal to turn on and turn the volume up for a television, or to turn on, select a radio, and turn the volume up for a stereo set. Image pick-up and image data transmission are performed in the same way as in Step S482.

With this, an intruder, who should have be considerably intimidated by lighting up or flashing a lamp, is further intimidated by a sudden loud sound. Even if only flashing a lamp did not intimidate the intruder considerably, a loud sound has a substantial effect because the intruder may be worried about neighbors.

Then, Step S496 determines whether or not there is an instruction to step up a fourth security level within a specified period of time, and Step S498 determines whether or not there is an “instruction to prohibit a step-up”. These determinations are the same as in steps S484 and S486. The family member is to send an E-mail including a word “Unnecessary” or “Step up”.

Step S500 corresponds to the fourth level security, and takes an image of the room after outputting a voice to prompt an intruder to leave the room and then transmits the image data via a wireless LAN. The CPU 11 causes the alarm generation device equipped with an voice synthesizing function and a speaker to generate a go-away message. Image pick-up and image data transmission are performed as in Step S482. If the go-away message is generated, an intruder will recognize that a full-fledged security system is installed and feel a substantial intimidation.

Then, Step S502 determines whether or not there is an instruction to step up to a fifth security level within a specified period of time, and Step S504 determines whether of not there is an “Step-up not allowed” instruction. These determinations are the same as in steps S484 and S486. A family member is to send an E-mail including a word “Unnecessary” or “Step up”.

Although only the securities mentioned above are sufficient, in Step S506 as the final security level (fifth security level), an alarm generation device outputs a voice telling that the intrusion has been reported to police, takes an image of the room, and transmits the image data through a wireless LAN. The CPU 11 causes said alarm generation device to generate a predetermined message to the effect that the intrusion has been reported to police. Whether or not the report is actually made depends on a local legal system. It is also possible to report to police through the security company, not directly to police. In this case, it is possible to use said wireless LAN module 71 to send an E-mail to the security company, or use an IP telephone function to call the security company to report the current security level as well as the information prerecorded with the voice generation function, including the address of the home and contact addresses of family members.

The steps S482, S488, S494, S500, and S506 described above correspond to the five security levels, and the CPU 11 that executes the security makes up the phased security execution control processor.

(4) Optional Operation of the Security Mode

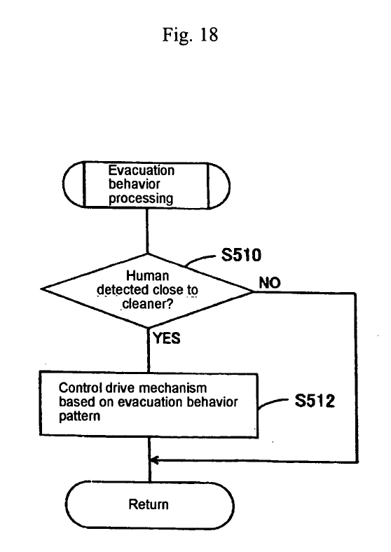

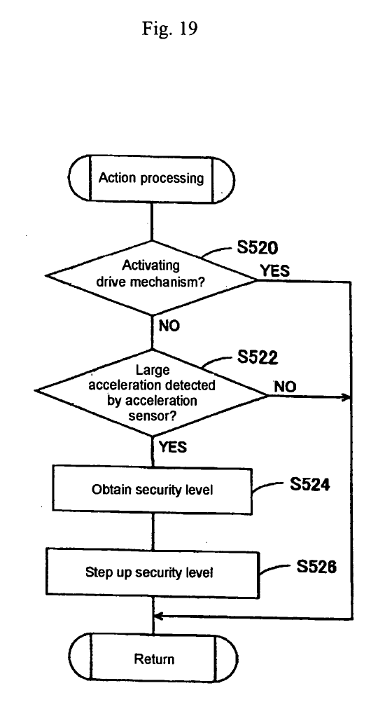

FIG. 18 and FIG. 19 are flowcharts showing optional operations that can be performed in addition to the security mode described above.

FIG. 18 shows a processing that realizes the same evacuation behavior as that shown in FIG. 16. If a phased security shown in FIG. 17 is executed, an intruder may notice the existence of the self-propelled cleaner of this invention because of its discretion. If an intruder recognizes that the cleaner serves as a guard, the intruder may attempt to break the cleaner. Therefore, Step S510 determines whether or not the cleaner detected a human close to the same, and if detected, controls the drive mechanism according to the evacuation behavior pattern in Step S512.

The determination of whether or not an intruder is present close to the cleaner can be made by setting distances corresponding to infrared intensities and determining whether an intruder is close to the cleaner, provided that the human sensor 21 outputs the infrared intensity. If the human sensor 21 simply outputs the presence or absence of an object emitting an infrared, it is possible to determine whether or not an intruder is close to the cleaner based on the number of the human sensors outputting detection result, assuming that a plurality of human sensors 21 reacts a human close to the cleaner.

An evacuation behavior processing like this is effective if it is executed periodically by means of timer interruption. Therefore, if it is determined that there is a detection output from the human sensor 21 in Step S400, the timer interruption is enabled and executed repeatedly.

In addition, an attack response processing may be executed concurrently with the above processing.

FIG. 19 shows a processing to be executed if the cleaner is attacked by an intruder. The cleaner takes an evacuation action but may be attacked before taking that action. If the intruder throws something to, kicks, or throws the cleaner, the cleaner will be shocked and in that case the security level is to be stepped up.

Step S520 determines whether or not the drive mechanism is activated. If not activated, Step S522 obtains an acceleration value from the acceleration sensor 44 and determines whether or not the value is larger than a predetermined threshold. The reason for determining whether or not the drive mechanism is activated in Step S520 is that a large acceleration value may be detected while the cleaner is traveling, resulting a malfunction.

If a large acceleration is detected while the cleaner is not traveling, Step S524 obtains the current security level and Step S526 steps up the security level by one level. For example, if the current security level is level 1, then the level will be escalated to level 2, and if level 2 then the level will be escalated to level 3.

It is also possible to escalate the level by more than one level at a time instead of one by one, or step up the level according to the intensity of a shock suffered. Needless to say, the phased security described above is only an example, it is possible to control the number of levels to be escalated according to the details of the phased security.

This attack response processing is also effective if it is executed periodically using the timer interruption or the like, as in the evacuation behavior processing. Accordingly, after it is determined whether or not there is a detection out put from the human sensor 21 in Step S400 the timer interruption is enabled and repeated.

As described above, the self-propelled cleaner of this invention allows a phased security, that is, when a human suspected of being an intruder is detected by the human sensor 21, the cleaner turns on the light (Step S482), flashes the same (S488), makes a loud sound (S494), generate a go-away message (S500), and generate an police report message (S506) step by step. At each stage, an image of the room is taken and sent to a family member and the cleaner determines whether or not the level should be escalated according to the instruction from the family member.

Thus, this invention allows the user to predetermine the security levels and step up the level according to the instruction from a family member, resulting in reduced malfunctions and improved reliability of the security.

The foregoing invention has been described in terms of preferred embodiments. However, those skilled, in the art will recognize that many variations of such embodiments exist. Such variations are intended to be within the scope of the present invention and the appended claims.

1. A self-propelled cleaner having a body equipped with a cleaning mechanism and a drive mechanism equipped with a plurality of drive wheels that are disposed on the left and right sides of said body and can be controlled to rotate individually to realize steering and driving said self-propelled cleaner, said body comprising:
a camera device capable of taking an image when so instructed and then outputting resultant image data;
a plurality of human sensors that are disposed on the sides of said body and detect a moving object emitting an infrared based on changes in the amount of receiving infrared;
a wireless transceiver that is equipped with a wireless LAN module, and capable of connecting to a wired LAN through a wireless LAN, communicating with the outside via said wired LAN and the Internet, transmitting predetermined data wirelessly to the outside, and receiving a plurality of instructions from the outside;
an infrared control signal transmitter capable of transmitting an infrared signal to control a plurality of electrical appliances in a room; and
a phased security execution control processor that, when intruder information is obtained from said human sensor, turns on one or plurality of lights in the room and takes an image of the room, transmits image data obtained from said camera device to the outside via said wireless transceiver, controls said electrical appliances in the room through said control signal transmitter based on a plurality of predetermined phased security instructions, responds to a plurality of instructions from the outside based on wireless communication with the outside via said wireless transceiver, and executes a plurality of security tasks step by step according to the plurality of said phased security instructions.

2. A self-propelled cleaner having a body equipped with a cleaning mechanism and a drive mechanism capable of steering and driving said self-propelled cleaner, further comprising:
a camera device capable of taking an image when so instructed and then outputting resultant image data;
a wireless transceiver capable of transmitting predetermined data to the outside and receiving a predetermined instruction from the outside;
a control signal transmitter to control a plurality of electrical appliances in a room;
an intruder information obtaining device to obtain intruder information; and
a phased security execution control processor that, based on a plurality of predetermined phased security instructions, when intruder information is obtained from said intruder information obtaining device, controls said plurality of electrical appliances, takes an image of the room with said camera device, communicate wirelessly with the outside through said wireless transceiver, and execute a plurality of security tasks step by step according to said plurality of phased security instructions in response to a plurality of instructions from the outside.

3. A self-propelled cleaner of claim 2, wherein:
said intruder information obtaining device is equipped with a human sensor that detects presence of a human within a predetermined range around said body; and
said phased security execution control processor controls said drive mechanism to travel on a predetermined route to realize an evacuation behavior, when a human is detected close to said self-propelled cleaner by said human sensor.

4. A self-propelled cleaner of claim 2, wherein:
said intruder information obtaining device is equipped with an acceleration sensor; and
said phased security execution control processor escalates a security level by more than one level at a time when a large acceleration indicating a shock is detected by said acceleration sensor.

5. A self-propelled cleaner of claim 2, wherein:
said control signal transmitter is equipped with an infrared signal transmitter that transmits an infrared signal to remote-control said electrical appliances; and
said phased security execution control processor controls said plurality of electrical appliances with said infrared signal.

6. A self-propelled cleaner of claim 5, wherein:
said phased security execution control processor takes an image of the room with said camera device after turning on the lights in the room with an infrared signal from said infrared signal transmitter and transmits the image data obtained from said camera device to the outside via said wireless transceiver.

7. A self-propelled cleaner of claim 6, wherein:
said phased security execution control processor responds to a plurality of instructions from the outside through wireless communications with the outside via said wireless transceiver, and transmits the image data obtained from said camera device to the outside via said wireless transceiver.

8. A self-propelled cleaner of claim 6, wherein:
said phased security execution control processor takes an image of the room periodically, and transmits the image data obtained from said camera device to the outside via said wireless transceiver.

9. A self-propelled cleaner of claim 5, wherein:
said phased security execution control processor intimidates an intruder by flashing the light in the room with an infrared signal from said infrared signal transmitter.

10. A self-propelled cleaner of claim 5, wherein:
said phased security execution control processor causes one of a plurality of audio apparatuses to make a sound with an infrared signal from said infrared signal transmitter.

11. A self-propelled cleaner of claim 2, wherein:
said wireless transmitter is equipped with a wireless LAN module and connected to a wired LAN through a wireless LAN, and communicates with the outside via said wired LAN.

12. A self-propelled cleaner of claim 2, wherein:
said control signal transmitter and said phased security execution control processor are equipped with an optional unit consisting of an infrared communication unit and an alarm generation device, and serves as a remote controller for the electrical appliance and lights in the room; and
said alarm generation device is equipped with a voice generation function and a speaker, and raises an alarm against an intruder.

13. A self-propelled cleaner of claim 2, wherein:
said phased security execution control processor determines whether or not there is a “Step-up not allowed” instruction based on whether a received E-mail includes a word “Unnecessary” or “Step-up not allowed”, when determining whether or not there is an instruction to step up security level within a specified period of time.

14. A self-propelled cleaner of claim 3, wherein:
it is determined whether or not said cleaner detected an human close to the cleaner, and if an human is detected close to the cleaner said drive mechanism is controlled based on evacuation behavior patterns.

15. A self-propelled cleaner of claim 14, wherein:
on the assumption that multiple human sensors react if an human approaches close to the cleaner if only the presence or absence of an object emitting an infrared, whether or not an human is close to the cleaner is determined based on the number of the human sensors that output detection results.

16. A self-propelled cleaner of claim 4, wherein
when said cleaner suffered a big shock, security level is jumped up to the final level, as the shock is considered as being caused by an attack by an intruder.

17. A self-propelled cleaner of claim 4, wherein
security level is escalated proportionally according to the intensity of a shock.

18. A self-propelled cleaner of claim 2, wherein:
security levels are predetermine and the level is escalated step by step according to the instruction from a family member, so that reduced malfunctions and improved reliability of the security can be achieved.
